(19) United States
(12) Patent Application Publication
(10) Pub. No.: US 2010/0163696 A1
(43) Pub. Date: Jul. 1, 2010

(54) BRACKET

(75) Inventors: Gay BRIGGS, London (GB); Derek Frank THOMPSON, Essex (GB)

Correspondence Address: NIXON PEABODY, LLP, 401 9TH STREET, NW, SUITE 900, WASHINGTON, DC, 20004-2128, US

(73) Assignee: RAREBASIC (COMBINATIONS) LIMITED, London (GB)

(21) Appl. No.: 11/995,956

(22) PCT Filed: Feb. 27, 2007
(86) PCT No.: PCT/GB07/00670

§ 371 Date: Aug. 25, 2008

(30) Foreign Application Priority Data
Feb. 27, 2006 (GB) 0603870.7

(51) Int. Cl. A47B 96/06; B23P 25/00

(52) U.S. Cl. 248/206.5; 29/458

(57) ABSTRACT

The present invention relates to a method of manufacture of a bracket (1) to be magnetically attached to a load supporting metallic surface (20), the bracket having a frame with a plurality of magnet fixing locations (6, 7). The method comprises the steps of:— a) mounting a planar magnet (4, 5) to each of said magnet fixing locations using a flowable settable bonding material; b) magnetically attaching a planar metallic sheet to said planar magnets; c) pressing the frame and metallic sheet together to apply a pressure to the bonding material prior to setting whereby all the magnets are accurately aligned on a common plane defined by the metallic sheet; and d) allowing the bonding material to set to fix each magnet to a said magnet fixing location.

The present invention relates to a bracket that is removably attachable to a load supporting metallic surface by means of magnets, and a method of manufacture of such brackets.

Devices called “fridge magnets” are well known. Generally, these comprise a magnet for attaching to a metallic surface such as a fridge door, together with a non-magnetic element which may serve simply as decoration, or which may be useful in other ways. For example, fridge magnets which act as pen holders or hooks on which small items can be hung are known. However, the usefulness of such fridge magnets is limited by the fact that they cannot be used to hold items above a certain weight, since this causes the fridge magnet to slide rapidly down the metallic surface, or fall, away from the surface altogether. Further, with lighter objects or even under the weight of the non-magnetic element alone, over time, the fridge magnet tends to slide gradually down the metallic surface.

In domestic, office and retail environments, brackets such as displays, shelf units, hanging rails or hooks are used for holding items such as books, clothes, shoes, etc in a position raised from the ground. Such units are typically fixed to a vertical surface such as an interior wall by means of screws or other permanent attachment means.

However, it is desirable to have brackets which are removably attachable to the wall surface, such that they can be readily detached from one position and re-attached at a different position, as this allows for flexibility in the arrangement of the brackets. In general, such brackets are weak and if made stronger require complex attachment means which make rearrangement of the brackets slow and cumbersome.

In principle, a fridge magnet could be made in the form of a bracket so as to provide a bracket that is removably attachable to a metallic surface. However, in practice, the type of bracket desirable for holding displays, books, clothes, shoes etc is too heavy to form the non-magnetic part of a fridge magnet, due to the drawbacks outlined above. Further, even if the weight of the bracket itself can be made sufficiently low, the bracket will only be able to hold very light objects without sliding down or falling away from the wall. Moreover, even with sufficiently light brackets used only for holding sufficiently light items, there is still the problem that, over time, the bracket will tend to slide gradually down the wall surface. This is undesirable because it means the position of the bracket has to be adjusted by hand at regular intervals if the chosen position of the bracket is to be maintained.

It is an object of the present invention to provide a bracket suitable for supporting books, clothes, shoes etc which is magnetically attachable to a surface.

According to a first aspect of the present invention there is provided a method of manufacture of a bracket to be magnetically attached to a load supporting metallic surface, the bracket having a frame with a plurality of magnet fixing locations on a common plane; the method comprising the steps of:—

a) mounting a planar magnet to each of said magnet fixing locations using a flowable settable bonding material;

b) magnetically attaching a planar metallic sheet to said planar magnets;

c) pressing the frame and metallic sheet together to apply a pressure to the bonding material prior to setting whereby all the magnets are accurately aligned on a common plane defined by the metallic sheet; and

d) allowing the bonding material to set to fix each magnet to a said magnet fixing location.

In this way, all the magnets are accurately aligned in a common plane, and gaps and air bubbles in the bonding material are forced out, thereby ensuring a good adhesive contact area between the magnets and the magnet fixing locations of the frame.

When a bracket made according to the method of this aspect of the invention is attached to the load supporting metallic surface, the magnetic attraction between the magnets and the load supporting metallic surface holds the bracket in place against downward and turning forces due to the weight of the bracket itself and the additional weight of items held thereby.

By providing the plurality of magnets to be accurately aligned on a common plane, the bracket is able to support significantly heavier loads than a bracket comprising a single magnetic surface of a similar size and strength, without either sliding down or being pulled away from the surface due to the aforementioned forces.

Unlike the prior art, the near perfect alignment of the magnets means that the plane of the magnets closely matches the plane of the load supporting magnetic surface to provide an efficient and effective magnetic attraction between the two.

Steps a) and b) may be reversed.

Preferably, the flowable settable bonding material is provided to said magnet fixing locations before the surface of the respective planar magnet is provided at the magnet fixing location.

The pressure of step c) may be applied through the weight of the frame.

The method may further include the step of providing each planar magnet with a slide resistant material.

This step can take place prior to step (b), such that the layer of slide resistant material is interposed between the magnet and the metallic sheet in step (b).

Alternatively, this step can take place after step d).

The slide resistant material can increase the friction between the load supporting metallic surface and the planar magnet when a bracket made according to the method is attached to a load supporting metallic surface. This further improves the resistance to downward forces to prevent the bracket sliding down the metallic surface.

Requiring that the layer of slide resistant material is interposed between the magnet and the metallic sheet in step (b) ensures that the application of the slide resistant material to the magnets does not affect the near perfect alignment of the magnets on the common plane.

The layer of slide resistant material may be part of a casing, envelope or sleeve formed around the planar magnet

The flowable settable bonding material is preferably an adhesive material and step (a) preferably comprises adhering a surface of a said planar magnet to a said magnet fixing location to mount the planar magnet to the magnet fixing location.

Alternatively or in addition, step (a) may comprise bonding a casing, envelope or sleeve of a said planar magnet to a said magnet fixing location to mount the planar magnet to the magnet fixing location.

In one case, said magnet fixing locations are arranged as one or more groups, each group comprising one or more pairs, and the magnets mounted to said pairs are arranged to have opposite poles facing one another.

It has been found that this configuration improves the strength of magnetic attraction between the bracket and the load supporting metallic surface. It will be appreciated that this configuration requires the use of planar magnets whose poles are located at opposite edges of the magnet (rather than on the planar surfaces).

In one case, one or more of the groups comprises two such pairs arranged in a square configuration.

According to a second aspect of the present invention, there is provided a bracket to be magnetically attached to a load supporting metallic surface, the bracket comprising:—

a frame having a plurality of magnet fixing locations provided on a common plane;

a planar magnet fixed to each of said magnet fixing locations; and

a layer of slide resistant material provided on at least part of a planar surface of each planar magnet such that the layer of slide resistant material will be interposed between the planar magnet and the load supporting metallic surface when the bracket is attached to the load supporting metallic surface.

The slide resistant material increases the friction between the metallic surface and the magnet, thereby improving the resistance to downward forces to prevent the bracket sliding down the metallic surface.

The layer of slide resistant material may be formed as a coating on the planar magnet.

Alternatively, the layer of slide resistant material may be part of a sleeve, envelope or casing formed around the planar magnet prior to fixing the planar magnet to a said magnet fixing location.

The layer of slide resistant material may be adhered to the planar magnet by means of adhesive.

In this case, the layer of slide resistant material is preferably impregnated with adhesive through at least part of the thickness thereof, to provide an adhesive surface by which the layer of slide resistant material is adhered to said planar surface of the planar magnet.

If a separate layer of adhesive is used to adhere the layer of slide resistant material to the planar surface of the planar magnet, the adhesive layer tends to delaminate (ie, to become separated from the layer of slide resistant material) during use of the bracket. Impregnating the layer of slide resistant material with adhesive means that the need for a separate layer of adhesive, and thus the risk of delamination is avoided.

The layer of slide resistant material preferably has a thickness of between 0.5 mm and 0.55 mm.

The layer of slide resistant material preferably has a Shore hardness of between 67 and 70.

If the hardness, and hence the density of the material, is too hard, then the magnet will not be able to compress the material therefore reducing the slide resistance. If the hardness is too soft, then the material can collapse and break in use.

An aperture may be formed in the layer of slide resistant material through which part of said planar surface of the planar magnet is exposed.

Since a portion of the planar surface of the planar magnet is exposed, the strength of the magnet attachment of the planar magnets to the metallic surface is improved, whilst the layer of slide resistant material still provides slide resistance.

The aperture is preferably substantially circular, and is preferably substantially concentric with said planar surface of the planar magnet. The layer of slide resistant material on the planar surface of the planar magnet will thus be an annular ring. The aperture may have a diameter of between approximately 5 mm to 10 mm, preferably 8 mm.

The bracket may further comprise a fixing means to fix each magnet to a said magnet fixing location whereby, after fixing, all the magnets are accurately aligned on a common plane.

When the bracket is attached to the load supporting metallic surface, the magnetic attraction between the magnets and the load supporting metallic surface holds the bracket in place against downward and turning forces due to the weight of the bracket itself and the additional weight of items held thereby.

By providing the plurality of magnets so that they are accurately aligned on a common plane, the bracket is able to support significantly heavier loads than a bracket comprising a single magnetic surface of a similar size and strength, without either sliding down or being pulled away from the surface due to the aforementioned forces.

The fixing means may comprise a flowable settable bonding material for mounting a said planar magnet to a said magnet fixing location.

The flowable settable bonding material may be an adhesive material which adheres a surface of a said planar magnet to a said magnet fixing location.

Alternatively or in addition, the flowable settable bonding material may bond a casing, envelope or sleeve of a said planar magnet to a said magnet fixing location.

The frame may be formed in the shape of a lower case letter “h” and a magnet fixing location may be provided at the base of each leg of the letter “h”.

The frame may be formed in the shape of two or more interlinked lower case letters “h”.

Thus, when the bracket is mounted to a vertical load supporting metallic surface, for use, the support means provides a horizontally extending surface from which items can be hung, or on which items can be placed. With this arrangement, the resistance to the downward and turning forces referred to above is improved.

Preferably, the bracket is for attachment to the load supporting metallic surface in a predetermined orientation and the plurality of magnet fixing locations are provided as one or more groups of two or more magnet fixing locations and the magnet fixing locations of a group are preferably substantially vertically aligned when the bracket is attached to the load supporting metallic surface in the predetermined orientation.

By providing that the magnetic fixing locations are substantially vertically aligned, the bracket is able to support still heavier loads without either sliding down or being pulled away from the surface due to the aforementioned forces.

The frame may be formed to connect the magnet fixing locations of a group by a load dispersing section.

In this case, the load dispersing section may have a generally arc shaped cross section in a vertical direction when the bracket is attached to the load supporting metallic surface.

In one case, said magnet fixing locations are arranged as one or more groups, each group comprising one or more pairs, and the magnets mounted to said pairs are arranged to have opposite poles facing one another.

It has been found that this configuration improves the strength of magnetic attraction between the bracket and the load supporting metallic surface. It will be appreciated that this configuration requires the use of planar magnets whose poles are located at opposite edges of the magnet (rather than on the planar surfaces).

The bracket may further comprise a frame having a plurality of individual discrete panels provided on a common plane, each having a plurality of said magnet fixing locations provided thereon, a planar magnets being fixed to each of said magnet fixing locations; and a load carrying means which extends from the separate magnet fixing panels.

Preferably, the individual discrete panels are connected together only in a region where the load carrying means extends therefrom.

According to a third aspect of the present invention, there is provided a bracket to be magnetically attached to a load supporting metallic surface, the bracket comprising:—

a frame having a plurality of individual discrete panels provided on a common plane, each having a plurality of planar magnets fixed thereto; and

a load carrying means which extends from the separate magnet fixing panels.

Preferably, the individual discrete panels are connected together only in a region where the load carrying means extends therefrom.

Since the magnet fixing panels are separated from one another, other than where the load carrying means extends therefrom, the magnetic flux which attaches the bracket to the metallic surface is also separated into parts. Accordingly, if one part fails, the remaining part or parts still act to attach the bracket to the metallic surface.

The load carrying means may comprise a shelf, or may comprise a plurality of bars.

The bracket preferably further comprises a fixing means to fix each magnet to a said individual discrete panel whereby, after fixing, all the magnets are accurately aligned on a common plane.

The bracket preferably further comprises a layer of slide resistant material provided on each planar magnet such that the layer of slide resistant material will be interposed between the planar magnet and the load supporting metallic surface when the bracket is attached to the load supporting metallic surface.

Examples of the present invention will now be described with reference to the accompanying drawings in which:—

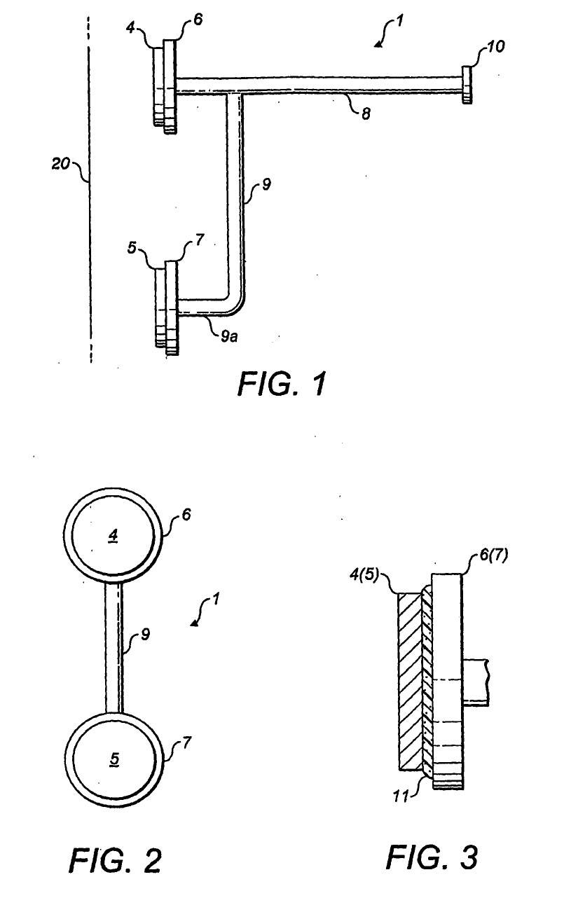

FIG. 1 is a side view of a bracket made according to a method which embodies the first aspect of the present invention and which embodies a second aspect of the present invention;

FIG. 2 is a rear view of the bracket shown in FIG. 1;

FIG. 3 is an enlarged side view of the wall mounting means of the bracket shown in FIG. 1;

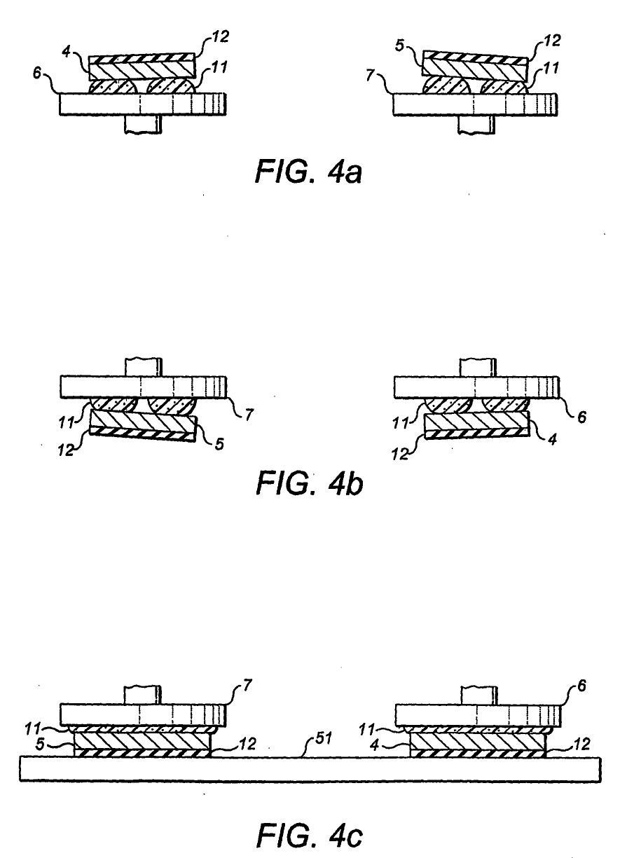

FIGS. 4a to 4c illustrate steps involved in a method which embodies the first aspect of the present invention;

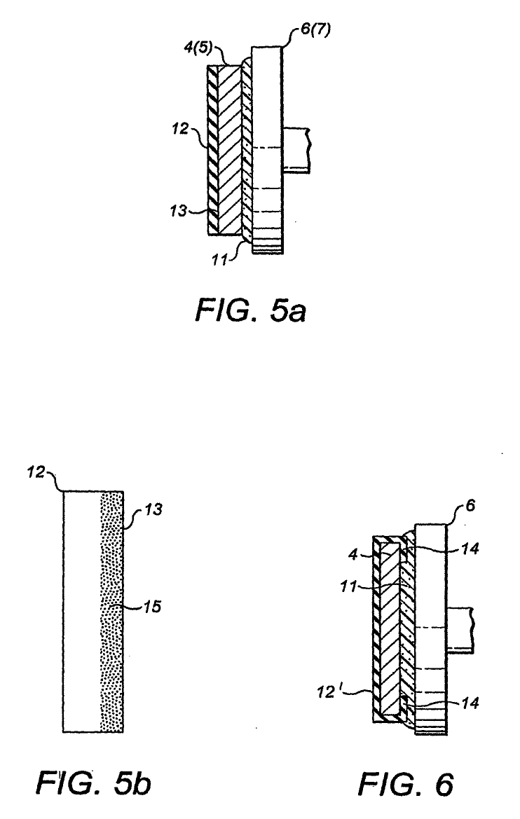

FIG. 5a is an, enlarged side view of part of a bracket made according to a method which embodies the first aspect of the present invention and which embodies a second aspect of the present invention;

FIG. 5b is an enlarged side view of the slide resistant layer shown in FIG. 5b;

FIG. 6 is an enlarged side view of part of another bracket made according to a method which embodies the first aspect of the present invention and which embodies a second aspect of the present invention;

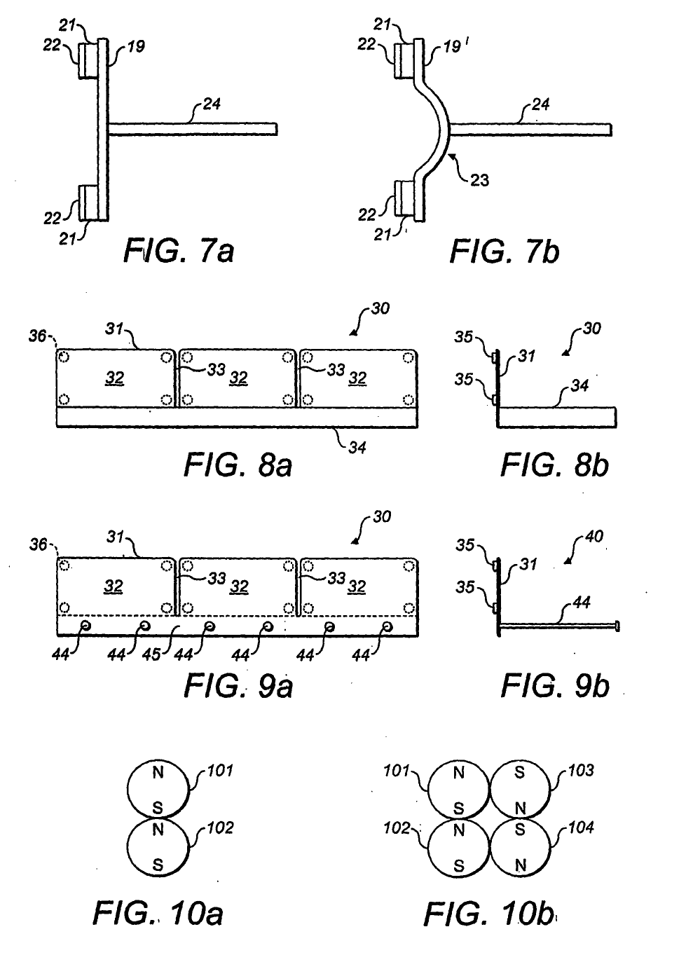

FIGS. 7a and 7b illustrate further brackets made according to a method which embodies the first aspect of the present invention and which embodies a second aspect of the present invention;

FIGS. 8a and 8b illustrate a further bracket made according to a method which embodies the first aspect of the present invention and which embodies the second aspect and third aspects of the present invention; and

FIGS. 9a and 9b illustrate a further bracket made according to a method which embodies the first aspect of the present invention and which embodies the second aspect and third aspects of the present invention.

FIGS. 10a and 10b illustrate a preferred arrangement of magnets for embodiments of the present invention.

Components common to different embodiments bear common reference numerals.

A bracket 1 made according to a method of the first aspect of the present invention and which embodies a second aspect of the present invention is shown in FIGS. 1 and 2. For clarity, the slide resistant member of the second aspect of the present invention is not shown in FIGS. 1 and 2.

The bracket 1 is magnetically attachable to a vertically aligned magnetizable (metallic) sheet or wall or surface 20. The frame of the bracket comprises an upper disk 6 and a lower disk 7 connected together by first and second bar portions 8, 9 such that the wall facing surfaces of the disks 6, 7 are located approximately on a common plane.

As illustrated in FIG. 1, the first bar portion 8 extends perpendicularly from the center of the non-wall facing surface of the upper disk 6, and terminates in an abutment 10. The second bar portion 9 extends perpendicularly from the first bar portion 8 (vertically as illustrated) from a point close to the upper disk 6. The second bar portion 9 is bent through a right angle near the end thereof to form an L-shape in which the end portion 9a of the second bar portion 9 forms the base of the L-shape. This end portion 9a extends parallel to the first bar portion 8 towards and terminating at the center of the non-wall facing surface of the lower disk 7.

The frame is thus formed in the shape of a lower case letter “h” with magnet fixing locations in the form of disks 6 and 7 provided at the base of each leg of the letter “h”. The disk 6 and the disk 7, as magnet fixing locations, have respective planar magnets 4 and 5 attached thereto.

FIG. 3 is an enlarged view of the magnet and magnet fixing location part of the bracket 1 shown in FIGS. 1 and 2. These take the form of a magnet 4 attached to the disk 6 by means of a layer of adhering or adhesive material 11 provided therebetween. The magnet 5 is attached in a similar manner to the disk 7.

The adhering material 11 can take the form of a suitable adhesive, or plastics material which provides an adequate bond between the magnet and the disk 7. For example, a plastics material which is malleable when heated, but which sets hard at room temperature may be used. The thickness of the layer of adhesive material 11 has been exaggerated in FIG. 3 for the purpose of clarity.

The adhering material preferably comprises a two part component system such as Acrylic Structural Adhesive Apollo A5068 adhesive and A5068B activator. The adhesive is based on methyl methacrylate.

With this type of adhesive, one component can be coated onto one surface and the other component can be coated onto the other surface. This type of system has a handling time of between 12-25 minutes and a full cure of 24 hours. Preferably the surfaces to be bonded should be clean, dry and degreased.

The present inventors have found that by accurately aligning the magnet surfaces on a common plane, the bracket is able to support significantly heavier loads than a bracket comprising magnets of a similar size and strength which are not so accurately aligned. In particular, it has been found that such brackets do not slip down when attached to the load supporting metallic surface 20 and are not easily pulled away from the sheet.

However, difficulties have been found in regulating the thickness of the adhesive layer between the magnets and the magnet fixing locations. Further, it will be appreciated that the bond between the magnets and the magnet fixing locations must be strong enough to prevent separation thereof during loading of the bracket.

The present invention provides a method by which it is possible to obtain a strong bond between the magnets and the magnet fixing locations whilst ensuring that the magnets are accurately aligned on a common plane.

An example of the method of the present invention for forming the brackets described above is described below with reference to FIGS. 4a to 4c.

Initially, the frame is formed by assembling the disks 6, 7, the bars 8, 9, and the abutment 10 with the wall facing surfaces of the disks 6, 7 lying approximately on a common plane. The frame can of course be integrally molded from plastics material.

Both planar surfaces of each magnet 4 and 5 are cleaned with alcohol. If required, a slide resistant surface in the form of tape or a membrane which has an adhesive surface for adhering to the magnet may be applied to the cleaned wall facing surface of each of the magnets 4, 5, and trimmed to shape if necessary (see FIG. 5a). Alternatively, the magnets may be encapsulated within a sleeve or envelope of slide resistant material, as shown in FIG. 6. The slide resistant surface will be described in more detail below in relation to FIGS. 5a, 5b and 6. It will be appreciated that in the method of the first aspect of the present invention, the application of a slide resistant surface is not necessarily required.

Once the frame of the bracket 1 is assembled, it is held with the wall facing surfaces of the disks 6 and 7 held horizontal and facing upwards. Adhesive 11 is then applied to the wall facing surfaces of the disks 6 and 7 and the non-wall facing surface of each magnet 4 and 5 is placed centrally on the disks 6 and 7 respectively over the adhesive 11, as shown in FIG. 4a. If the two part component adhesive mentioned above is used, then the adhesive is applied to the surface of the magnets whilst the activator is applied to the disks.

As can be seen from FIG. 4a, at this stage, the adhesive 11 has not formed a smooth layer. For example, gaps or air bubbles may exist between the respective surfaces. Further, whilst the wall facing surfaces of the disks 6, 7 are aligned approximately on the same plane, the arrangement of the adhesive 11 may mean that the wall facing surfaces of the magnets 4, 5 lie on generally different planes to one another at this stage.

The adhesive material 11 that is used is selected to be a flowable settable adhesive material 11. Thus, the unset adhesive 11 holds the magnets 4, 5 in place, allowing the bracket to be turned over so that the wall facing surfaces of the magnets 4, 5 are horizontal and face downwards, as shown in FIG. 4b. Once in this orientation, the bracket is magnetically attached to a metal sheet 51 which has an accurate planar surface. It will be appreciated that the metal sheet 51 must be strong enough such that its accurate planar nature is not distorted by the action of the magnets.

As can be seen from FIG. 4c, the weight of the bracket presses the magnets 4 and 5 into a position in which their wall facing surfaces (the slide resistant surfaces 12) are accurately aligned on a common plane. Moreover, any gaps or air bubbles in the adhesive layer 11 are forced out as the adhesive flows under the pressure of the weight of the bracket so that a good adhesive contact occurs between the magnets 4, 5 and the discs 6, 7.

Thereafter, the bracket is left until the adhesive layer 11 is fully set. Consequently, the method of forming the brackets described above enables a good bond to be achieved between the magnets 4, 5 and the magnet fixing locations (discs) 6 and 7 whilst accurately aligning the magnet surfaces on a common plane.

In cases where the weight of the bracket is not sufficient for the above purpose, further weights may be added to press the bracket against the sheet 51.

It should be noted that the magnets could alternatively be initially located on the metal sheet 51 at predetermined positions, and then the frame located so that the magnet fixing locations align with the magnets. Whilst the method has been described with the metal sheet 51 below the frame, it will be understood that the metal sheet could be provided above the frame with the frame inverted compared with FIG. 4c.

It will be appreciated by those skilled in the art that the above described method is straightforward to adapt to achieve the same purpose with alternative brackets.

In particular, with reference to FIG. 6, in the case where the magnets are encapsulated within a sleeve or envelope of slide resistant material, sufficient adhesive material should be provided such that when the bracket is pressed against the metal sheet 51, a good contact is achieved between both the rim 14 of the sleeve 12′ and the exposed section of the magnet 4, and the magnet fixing location 6.

It should be noted that the adhesive layer 11 may be replaced by a layer of a plastics material. In this respect, the plastics material is applied to the magnet fixing locations either preheated or heated in situ to a temperature at which it is malleable. The non-wall facing surfaces of the magnets are then placed centrally on the plastics material and the bracket inverted and pressed against a planar surface before the plastics material has cooled to its setting temperature.

In the above described methods, the layer of adhesive/plastics material is applied to the magnet fixing locations, and then the magnets are placed over the adhesive/plastics material. As an alternative, the layer of adhesive/plastics material can be applied to the magnets and then the magnet fixing locations can be placed over the adhesive/plastics material. For example, the magnets could be located onto the sheet 51 in predetermined positions, followed by applying adhesive material or plastics material to the non-wall facing surface of the magnets, and then locating the magnet fixing locations onto the adhesive material on the magnets.

The magnets 4, 5 used in present embodiment are permanent neodymium magnets grade N38, available from Sanders Magnet Service, Industrie Park 3, Geldrop, Netherlands. They are disk-shaped and are approximately 2 mm thick and approximately 22 mm in diameter. The magnetic strength of the material of the magnets changes only negligibly with time, the losses being estimated at less than 1×10⁶% per year. Further, the magnets have a maximum working temperature of 80° C., with negligible losses down to −100° C., and a working temperature range of −20° C. to 80° C.

The planar magnets 4, 5 preferably have their north and south (opposite) poles on opposite edges of the magnets (rather than on the planar surfaces). When the magnets 4, 5 are fixed to the discs 6, 7, they are preferably arranged such that a pole of one magnet faces the opposite pole of the other magnet. For example, the north pole of both magnets 4, 5 face upwards, such that the south pole of the upper magnet 4, faces the north pole of the lower magnet 5.

Although disc-shaped (circular planar) magnets are used in the present embodiment, other forms and shapes of magnet may also be used, provided they have at least one planar surface for use as the wall facing surface and can be bonded to the magnet fixing locations.

In general, since stronger magnets tend to be larger and more expensive than weaker magnets, the strength of the magnets used for the bracket may be selected according to the required upper limit on the weight that can be supported.

In this respect, the bracket shown in FIGS. 1 to 3 functions very well. However, it has been found that if suitable magnets are not selected, the bracket can slip down the metallic wall 20 over time the timescale varying from hours upwards.

The second aspect of the present invention addresses this problem. FIG. 5a is an enlarged side view of part of a bracket which embodies a second aspect of the present invention. The bracket of this embodiment is similar to the bracket shown in FIGS. 1 to 3. However, as shown in FIG. 5a, in order to enable weaker magnets to be used without the bracket slipping down the wall over time, a layer of slide resistant material 12 is bonded to the wall facing surface of each of the magnets 4, 5 via an adhesive surface 13 of the slide resistant material.

The slide resistant material is shown in more detail in FIG. 5b. The slide resistant material is a polyurethane rubber (elastomar) membrane 12 with a thickness of between 0.5 mm and 0.55 mm. A membrane having a Shore hardness of between 67 and 70 has been found to be particularly effective. If a harder material is used, the slip resisting effect is reduced whilst if a softer material is used, the membrane tends to break up over time. In this respect, it has been found that an acrylic adhesive is not particularly effective at adhering the membrane to the magnet.

It has been found that better results are obtained in the polyurethane rubber membrane is impregnated with adhesive 15 through surface 13 such that adhesive particles are dispersed through approximately half the thickness of the membrane. The impregnated adhesive causes surface 13 to be an adhesive surface, which bonds securely to the wall facing surface of the magnets 4, 5.

Whilst FIG. 5a has been described with a polyurethane rubber membrane used as the slide resistant material, alternative materials may be used. For example, a rubber-like material such as latex or silicone can be employed. Moreover, instead of impregnating slide resisting material with adhesive, a separate layer of adhesive may be provided. For example, the membrane may be adhered to the magnet using an adhesive rubber 4000 series. Further alternatively, the slide resistant material used can take the form of masking tape, which comprises a layer of slide resistant material with an adhesive backing layer. However, using a slide resistant material with an impregnated adhesive is preferable to using a slide resistant material with a separate backing layer, because this avoids the potential problem of the slide resistant material delaminating (ie, the layer of slide resistant material becoming separated from the adhesive layer) during use of the bracket.

It has been found that further improved performance can been obtained if the slide resistant material is provided in the form of an annular ring such that the material is provided around the perimeter of the magnet (this applies if the magnet has a form other than circular). A polyurethane elastomer membrane ring with a thickness of 0.4 to 0.5 mm (preferably 0.5 mm) has been found to be particularly effective at resisting slippage. For a magnet with a diameter of about 22 mm, the ring shaped membrane preferably has a circular aperture in the middle of about 8 mm in diameter and a diameter of about 22 mm to match that of the magnet.

A slide resistant surface may also be achieved by providing a slide resistant coating directly to the magnet. Alternatively, as shown in FIG. 6, the magnets may be encapsulated within a sleeve or envelope of slide resistant material. In this embodiment, the magnet 4 is encapsulated within a sleeve 12′ of slide resistant material. An adhesive layer 13 does not necessarily then need to be provided because the magnet is retained within the sleeve 12′ by the rim 14 of the sleeve 12′. However, in this case it is important that the adhesive layer 11 adheres at least to the exposed section of the magnet 4 and the disc 6 and preferably to the rim 14 as well.

In this way, the magnet 4 is prevented from moving within the sleeve 12′, thereby reducing wear from inside the sleeve. At the same time, the sleeve is prevented from moving relative to the frame of the bracket. This ensures that the outermost wall facing layer of the magnet (ie, the slide resistant surface provided by the sleeve) will remain aligned on a common plane.

Layers 11, 12, 12′ and 13 have been exaggerated for the purposes of clarity. Thus, FIGS. 5a and 6 are not to scale.

In use, a bracket 1 made according to the method of the first aspect of the present invention, or embodying the second aspect of the invention is located as desired on the vertical metallic surface of the wall 20. The bracket is thus held in place by the magnetic attraction between the magnets 4, 5 and the metallic surface of the wall 20. In this way, the first bar 8 then extends perpendicularly from the surface 20 to act as a hook for carrying items such as clothes hangers. The abutment 10 prevents items carried on the first bar 8 falling off the end thereof. Alternatively, two or more brackets may be mounted spaced apart at the same height above the ground to support a shelf on which further items can be placed. In this case, the abutments 10 prevent the shelf sliding off the first bars 8.

It has been found that by locating the bracket 1 on the vertical metallic surface of the sheet 20 in a predetermined orientation with the magnet 4 disposed to be vertically aligned above the magnet 5, the bracket of the present invention is able to support even greater loads than hitherto and in particular is able to support loads equivalent to those supported by frames which use much stronger and larger magnets which are not so aligned.

Indeed, the bracket can be modified such that it has two or more magnets disposed to be vertically aligned one above another. Moreover, additional supporting strength can be provided if the bracket is modified such that it has a number of groups of two or more magnets disposed to be vertically aligned one above another.

The bracket illustrated in FIG. 1 can disengaged from the metallic wall 20 by applying a turning force around the vertical axis. In this way, the bracket can be easily relocated.

FIGS. 7a and 7b illustrate further embodiments of the second aspect of the present invention.

Referring to FIG. 7a, the frame takes the form of a planar oblong metal plate 19 having an elongate rod 24 depending perpendicularly therefrom at the centre of the oblong. Each of the shorter sides of the oblong plate has an oblong magnet 21 of identical shape and strength adhered thereto, each magnet also having a slide resistant material 22 provided on the wall facing side of the magnet. The magnets, in use, would be at the upper and lower ends of the bracket when attached to a load supporting metallic surface. For clarity, the adhesive materials used for the magnet and slide resistant material are not shown, but can take the same form in this embodiment as those described above. With the particular strengths and size of magnet it has been found that a weight of 7 kg can be hung from the rod 24 before the bracket of FIG. 7a detaches from the load supporting metallic surface 20.

Referring to FIG. 7b, the dimensions and magnet strength are the same as in FIG. 7a. In this embodiment, the frame takes the form of an oblong metal plate 19′ having an elongate rod 24 depending perpendicularly therefrom at the centre of the oblong. Each of the shorter sides of the oblong plate has a planer area to which identically shaped and strength oblong magnets 21 are adhered, each magnet also having a slide resistant material 22 provided, on the wall facing side of the magnet. Between the aforesaid planar areas, the metal plate 19′ is bent to have a section 23 which is curved or arc shaped in cross section. For clarity, the adhesive materials used for the magnet and slide resistant material are not shown, but can take the form in this embodiment as those described above.

It can be seen that the bracket shown in FIG. 7b is identical to that of FIG. 7a except for the arc shaped section 23. With the same strengths and size of magnet as used for FIG. 7a it has been found that a weight of 17 kg can be hung from the rod 24 before the bracket of FIG. 7b detaches from the load supporting metallic surface 20. The section 23 appears to flex slightly.

It is believed that the load applied to the rod 24 is dispersed by the arc shaped section 23 or in some way orients the pulling force exerted by the areas at either end of the plate 19′ such that they are more aligned with the magnetic force of attraction between the magnets 21 and the sheet 20 by comparison with the bracket of FIG. 7a. It will be appreciated that the section 23 can take different forms as a load dispersing function.

The bracket of the invention is magnetically attached to a wall or ceiling surface. The nature of the surface can take many forms, for example metal sheets which are painted or wallpapered. The term “load supporting metallic surface” as used herein, refers to any load supporting surface to which magnets can be magnetically attached. Thus, a load supporting surface which comprises a metallic layer, or a laminated metallic sheet, would constitute a metallic surface even if covered by one or more a non-metallic layers.

It as preferable that the load supporting metallic surface is thick enough so as to reduce magnetic bleed therethrough. This enables the magnetic attraction to the sheet to be improved and can be illustrated by testing if metallic particles adhere widely on the reverse side of the sheet opposite the location where the bracket is fixed.

FIGS. 8a, 8b, 9a and 9b illustrate brackets which embody of a third aspect of the present invention. Although these brackets are described for the purpose of explaining the third aspect of the present invention, these brackets could be made according to a method embodying the first aspect of the invention.

FIGS. 8a and 8b are front and side views respectively of a bracket 30 for attachment via magnets to a metallic surface or wall. The bracket 30 comprises a shelf 34 and a wall mounting panel 31. The shelf 34 extends from the bottom of the wall mounting panel 31, away from the wall facing surface thereof, and extends from across substantially the full width of the wall mounting panel. The wall mounting panel 31 is separated by vertical channels into three smaller panels 32. Each of these smaller panels has a planar magnet 35 fixed in the corner thereof. Although the magnets themselves would not be visible in the view of FIG. 8a, their locations 36 are indicated in dotted outline in this figure. The planar magnets 35 are fixed to a wall facing surface of the wall mounting panel 31 such that they are accurately aligned in a common plane.

The vertical channels 33 separate the magnetic flux which attaches the bracket to the metallic surface into three parts. Accordingly, if one part fails, the two remaining parts still act to attach the bracket to the metallic surface. For example, if the accurate planar alignment of the planar magnets 35 on one of the panels 32 is lost through some minor distortion of the panel, the magnetic strength with which this panel attaches the bracket to the metallic surface will be reduced. However, due to the separation of this panel from the other panels, the distortion of this panel will not affect the accurate planar alignment of the magnets on the other panels, and will thus not affect the strength with which these panels attach the bracket to the metallic surface. In contrast, if the wall mounting panel 31 were to consist of one continuous panel, a minor distortion in one small area of this panel would affect the accurate planar alignment of all the magnets fixed thereto, and would thus reduce the strength with which the bracket is attached to the metallic surface, over the entire panel.

The frame of the bracket of FIGS. 8a and 8b may be formed by folding a continuous plastic or metal sheet (or a sheet of an alternative suitable material) through a right angle to form the wall mounting panel 31 and the shelf 34, and then cutting the vertical channels 33 to separate the panel 31 into the smaller panels 32. Alternatively, the frame could be formed by mounting the smaller panels 32 separately to the rear of the shelf 34. Other alternative means of manufacture will be readily apparent to the skilled person.

FIGS. 9a and 9b are front and side views respectively of a bracket 40, similar to the bracket 30 shown in FIGS. 8a and 8b, except that the shelf 34 is replaced by a plurality of bars 44 which extend from near the bottom of the wall mounting panel 31, away from the wall facing surface thereof. In this embodiment, instead of the panels 32 being connected by the shelf 34, the panel 31 comprises a continuous portion 45 which extends across the width of the bracket in a region where the bars 44 extend therefrom, and which connects the panels 32.

The shelf 34 or the plurality of bars 44 (the load supporting means) of these embodiments may be provided at the bottom or the top of the wall mounting panel 31, or at any height in between, provided the panels are connected in the region from which the load supporting means extends.

The described embodiments of the third aspect of the present invention have three smaller panels 32. However, any number of such panels greater than one may be provided.

The planar magnets may be provided with a slide resistant surface on a wall facing surface thereof. In this case the brackets of FIGS. 8a, 8b, 9a and 9b will embody the second aspect of the present invention.

In another embodiment of the various alternative embodiments described above, the magnet fixing locations are arranged as one or more groups, each group comprising one or more pairs, and the magnets mounted to said pairs are arranged to have opposite poles facing one another. One example of such a group is shown in FIG. 10a. In this case, a pair of magnets are mounted to the magnet fixing locations substantially vertically aligned when the bracket is attached to the load supporting metallic surface in a predetermined orientation. The two N poles are facing upwards and the S poles are facing southwards such that one N pole faces another S pole. Any suitable number of such groups can be provided.

Another example of such a group is shown in FIG. 10b in a square configuration. In this case, the pair of magnets shown in FIG. 10a is placed side by said another pair of such magnets which has been inverted as illustrated. Thus, N poles face S poles. Any suitable number of such groups can be provided and any suitable number of pairs.

It has been found that this configuration improves the strength of magnetic attraction between the bracket and the load supporting metallic surface. It will be appreciated that this configuration requires the use of planar magnets whose poles are located at opposite edges of the magnet (rather than on the planar surfaces).

The present inventors have found that a group of magnets arranged in this way have a greater strength than a single magnet of the same overall size as the group of magnets.

Although disc-shaped (circular planar) magnets are used in the present embodiment, other forms and shapes of magnet may also be used, provided they have at least one planar surface for use as the wall facing surface and can be bonded to the magnet fixing locations.

It will be appreciated by those skilled in the art that brackets made according to the method of the first aspect of the present invention, or embodying the second aspect of the present invention may take a variety of forms, provided the frame comprises a plurality of magnet fixing locations to which planar magnets may be fixed. For example, the frame may consist of one or more bars, one or more metal sheets, a rectangular block, etc. The frame may also be produced in different materials provided an adequate bond can be provided between the magnet and the magnet fixing locations.

1. A method of manufacture of a bracket to be magnetically attached to a load supporting metallic surface, the bracket having a frame with a plurality of magnet fixing locations; the method comprising the steps of:—
a) mounting a planar magnet to each of said magnet fixing locations using a flowable settable bonding material;
b) magnetically attaching a planar metallic sheet to said planar magnets;
c) pressing the frame and metallic sheet together to apply a pressure to the bonding material prior to setting whereby all the magnets are accurately aligned on a common plane defined by the metallic sheet; and
d) allowing the bonding material to set to fix each magnet to a said magnet fixing location.

2. A method as claimed in claim 1 wherein steps a) and b) are reversed.

3. A method as claimed in claim 1 or 2 wherein the flowable settable bonding material is provided to said magnet fixing locations before the surface of the respective planar magnet is provided at the magnet fixing location.

4. A method as claimed in any preceding claim wherein the pressure of step c) is applied through the weight of the frame.

5. A method as claimed in any preceding claim further comprising the step of providing each planar magnet with a slide resistant material prior to step (b), such that the layer of slide resistant material is interposed between the magnet and the metallic sheet in step (b).

6. A method as claimed in claim 5 wherein the layer of slide resistant material is part of a casing, envelope or sleeve formed around the planar magnet.

7. A method as claimed in any preceding claim wherein the flowable settable bonding material is an adhesive material and step (a) comprises adhering a surface of a said planar magnet to a said magnet fixing location to mount the planar magnet to the magnet fixing location.

8. A method as claimed in any preceding claim wherein step (a) comprises bonding a casing, envelope or sleeve of a said planar magnet to a said magnet fixing location to mount the planar magnet to the magnet fixing location.

9. A method as claimed in any preceding claim wherein, in step (a), the planar magnets are mounted to the magnet fixing locations such that at least one pole of each planar magnet faces an opposite pole of an adjacent planar magnet.

10. A method of manufacture of a bracket to be magnetically attached to a load supporting metallic surface, substantially as hereinbefore described with reference to the accompanying drawings.

11. A bracket to be magnetically attached to a load supporting metallic surface, the bracket comprising:—
a frame having a plurality of magnet fixing locations provided on a common plane;
a planar magnet fixed to each of said magnet fixing locations; and
a layer of slide resistant material provided on at least part of a planar surface of each planar magnet such that the layer of slide resistant material will be interposed between the planar magnet and the load supporting metallic surface when the bracket is attached to the load supporting metallic surface.

12. A bracket as claimed in claim 11 wherein the layer of slide resistant material is part of a sleeve, envelope or casing formed around the planar magnet prior to fixing the planar magnet to a said magnet fixing location.

13. A bracket as claimed in claim 11 or 12 wherein the layer of slide resistant material is adhered to the planar magnet by means of adhesive.

14. A bracket as claimed in claim 13 wherein the layer of slide resistant material is impregnated with adhesive through at least part of the thickness thereof, to provide an adhesive surface by which the layer of slide resistant material is adhered to said planar surface of the planar magnet.

15. A bracket as claimed in claim 11 wherein the layer of slide resistant material is formed as a coating on the planar magnet.

16. A bracket as claimed in any one of claims 11 to 15 wherein the layer of slide resistant material has a thickness of between 0.5 mm and 0.55.

17. A bracket as claimed in any one of claims 11 to 16 wherein the layer of slide resistant material has a Shore hardness of between 67 and 70.

18. A bracket as claimed in any one of claims 11 to 17 wherein an aperture is formed in the layer of slide resistant material through which part of said planar surface of the planar magnet is exposed.

19. A bracket as claimed in claim 18 wherein the aperture is substantially circular.

20. A bracket as claimed in claim 18 or 19 wherein the aperture is substantially concentric with said planar surface of the planar magnet.

21. A bracket as claimed in any one of claims 11 to 20, further comprising a fixing means to fix each magnet to a said magnet fixing location whereby, after fixing, all the magnets are accurately aligned on a common plane.

22. A bracket as claimed in claim 21 wherein the fixing means comprises a flowable settable bonding material for mounting a said planar magnet to a said magnet fixing location.

23. A bracket as claimed in claim 22 wherein the flowable settable bonding material is an adhesive material for adhering a surface of a said planar magnet to a said magnet fixing location.

24. A bracket as claimed claim 22 or 23 wherein the flowable settable bonding material is for bonding a casing, envelope or sleeve of a said planar magnet to a said magnet fixing location.

25. A bracket as claimed in any one of claims 11 to 24 wherein the frame is formed in the shape of a lower case letter “h” and a magnet fixing location is provided at the base of each leg of the letter “h”.

26. A bracket as claimed in claim 25 wherein the frame is formed in the shape of two or more interlinked lower case letters “h”.

27. A bracket as claimed in any one of claims 11 to 26, for attaching to the load supporting metallic surface in a predetermined orientation wherein the plurality of magnet fixing locations are provided as one or more groups of two or more magnet fixing locations and wherein the magnet fixing locations of a group are substantially vertically aligned when the bracket is attached to the load supporting metallic surface in the predetermined orientation.

28. A bracket as claimed in claim 27 wherein the frame is formed to connect the magnet fixing locations of a group by a load dispersing section.

29. A bracket as claimed in claim 28 wherein the load dispersing section has a generally arc shaped cross section in a vertical direction when the bracket is attached to the load supporting metallic surface.

30. A bracket as claimed in any one of claims 11 to 29 wherein the planar magnets are mounted to the magnet fixing locations such that a pole of each planar magnet faces an opposite pole of an adjacent planar magnet.

32. A bracket as claimed in any one of claims 11 to 30
further comprising:—
a frame having a plurality of individual discrete panels provided on a common plane, each having a plurality of said magnet fixing locations provided thereon, a planar magnets being fixed to each of said magnet fixing locations; and
a load carrying means which extends from the separate magnet fixing panels.

33. A bracket as claimed in claim 32 wherein the individual discrete panels are connected together only in a region where the load carrying means extends therefrom.

34. A bracket to be magnetically attached to a load supporting metallic surface, the bracket comprising:—
a frame having a plurality of individual discrete panels provided on a common plane, each having a plurality of planar magnets fixed thereto; and
a load carrying means which extends from the separate magnet fixing panels.

35. A bracket as claimed in claim 34 wherein the individual discrete panels are connected together only in a region where the load carrying means extends therefrom.

36. A bracket as claimed in claim 34 or 35 wherein the load carrying means comprises a shelf.

37. A bracket as claimed in claim 34 or 35 wherein the load carrying means comprises a plurality of bars.

38. A bracket as claimed in any one of claims 34 to 37 further comprising a fixing means to fix each magnet to a said individual discrete panel whereby, after fixing, all the magnets are accurately aligned on a common plane.

39. A bracket as claimed in any one of claims 34 to 38 further comprising a layer of slide resistant material provided on each planar magnet such that the layer of slide resistant material will be interposed between the planar magnet and the load supporting metallic surface when the bracket is attached to the load supporting metallic surface.

40. A bracket to be magnetically attached to a load supporting metallic surface, substantially as hereinbefore described with reference to the accompanying drawings.
